(19) United States
(12) Patent Application Publication
(10) Pub. No.: US 2021/0042857 A1
(43) Pub. Date: Feb. 11, 2021

(54) INFORMATION PROCESSING APPARATUS AND METHOD FOR CONTROLLING THE SAME, AND NON-TRANSITORY COMPUTER-READABLE STORAGE MEDIUM

(71) Applicant: CANON KABUSHIKI KAISHA, Tokyo (JP)

(72) Inventor: Kentaro Saito, Kawasaki-shi (JP)

(21) Appl. No.: 16/985,676

(22) Filed: Aug. 5, 2020

(30) Foreign Application Priority Data
Aug. 5, 2019 (JP) 2019-143920

(51) Int. Cl. G06Q 50/02; H04L 29/08; G06F 16/903; G06Q 30/02

(52) U.S. Cl. CPC G06Q 50/02; G06Q 30/0201; G06F 16/90335; H04L 67/12

(57) ABSTRACT

This invention provides an information processing apparatus configured to manage and aggregate information relating to crops in a farm field, comprising a management which receives and manages investigation data relating to crops in a farm field or to the farm field, a determination unit which determines, upon reception of the investigation data by the management unit, whether or not an aggregation timing of the investigation data has arrived, based on whether or not number of investigation data managed by the management unit has exceeded a predetermined number determined in accordance with investigation; and an aggregation unit which performs an aggregation process of the investigation data in response to a query of the investigation data, when the determination unit determines that the aggregation timing has arrived.

### BACKGROUND OF THE INVENTION

### Field of the Invention

The present invention relates to a technique for managing and aggregating investigation data in farming.

### Description of the Related Art

In order to produce top-quality wine, the quality of grapes turns out to be one of important factors. In addition, when blending a plurality of types of grapes to produce wine, it is important to predict the yield and make a production plan before harvest. Therefore, it is required in wine grape cultivation to perform various investigations such as disease and pest investigation, degree of growth investigation, degree of maturity investigation, yield prediction investigation or the like.

In a large-scale winery, cultivation management in the farm field and wine production management are performed in a labor-divided manner. In addition, wine may be produced using grapes harvested in a plurality of farm fields. Therefore, it is necessary for a person in charge of wine production to remotely refer to investigation results of the farm fields without knowing the details of progress of investigation in the farm fields.

Japanese Patent Laid-Open No. 2008-257449 discloses a conventional technique for remotely referring to farm field information. In the conventional technique according to the aforementioned document, an IoT sensor is set in a farm field, and an information processing apparatus acquires investigation data of the farm field from the IoT sensor at a regular time interval, and performs an aggregation process. Aggregation results provided by the information processing apparatus can be remotely referred to on a farmer's PC.

On the other hand, various investigations for wine grape cultivation may be subject to change of investigation plan due to external factors such as weather and growth conditions. Additionally, in a large farm field, there may be a case where investigation with a certain purpose is performed over a plurality of days, or performed by a plurality of investigators. Therefore, investigation data for a certain investigation are supposed to be uploaded to the information processing apparatus for a plurality of times on an irregular basis.

Additionally, in wine grape cultivation, a plurality of investigations may be planned and performed concurrently. In addition, it also happens in a large farm field that a plurality of investigators perform a same investigation in a shared manner, the investigators reporting investigation results at respective timings. In such a situation, the tasks associated with progress management of investigation and aggregation of investigation results are troublesome, with a large burden imposed on the worker performing the task.

In such a situation, conventional techniques having been performing aggregation processes at a regular time interval. In this case, it occasionally happens that the aggregation process is performed before all the investigation data with a certain investigation purpose are uploaded to the information processing apparatus. Effectively, the information processing apparatus may disclose a different aggregation result from that of aggregation using all the investigation data. As a result, there is a possibility of referring to an aggregation result aggregated based on insufficient investigation data, which leads to an erroneous decision.

In addition, taking an excessively long aggregation interval to solve the aforementioned problem may result in a long time lag from completion of all the investigations with a certain purpose to the aggregation process. In other words, taking a longer aggregation interval will result in delayed decision and action thereby.

### SUMMARY OF THE INVENTION

According to an aspect of the invention, there is provided an information processing apparatus configured to manage and aggregate information relating to crops in a farm field, comprising: a management unit configured to receive and manage investigation data relating to crops in a farm field or to the farm field; a determination unit configured to determine, upon reception of the investigation data by the management unit, whether or not an aggregation timing of the investigation data has arrived, based on whether or not number of investigation data managed by the management unit has exceeded a predetermined number determined in accordance with investigation; and an aggregation unit configured to perform an aggregation process of the investigation data in response to a query of the investigation data, when the determination unit determines that the aggregation timing has arrived.

According to the present invention, it becomes possible to provide more appropriate and meaningful information for grasping the condition of crops, as compared to conventional techniques.

Further features of the present invention will become apparent from the following description of exemplary embodiments (with reference to the attached drawings).

### BRIEF DESCRIPTION OF THE DRAWINGS

FIG. 1 is a configuration diagram of a farm field investigation system according to an embodiment.

FIG. 2 is a hardware configuration diagram of an information processing apparatus.

FIG. 3 is a flowchart illustrating a process procedure of an information processing apparatus according to a first embodiment.

FIG. 4 is a flowchart illustrating the filtering process of FIG. 3.

FIG. 5 is a flowchart illustrating the determination process of FIG. 3.

FIG. 6 illustrates a table of investigation categories according to the embodiment.

FIG. 7 illustrates a table of investigation data according to the embodiment.

FIGS. 8A and 8B illustrate tables of investigation plan and investigation history according to the embodiment.

FIGS. 9A and 9B illustrate tables of investigation categories and investigation plans according to another embodiment.

FIGS. 10A and 10B illustrate tables of investigation data reception management and aggregation management in another embodiment.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made an invention that requires all such features, and multiple such features may be combined as appropriate. Furthermore, in the attached drawings, the same reference numerals are given to the same or similar configurations, and redundant description thereof is omitted.

### First Embodiment

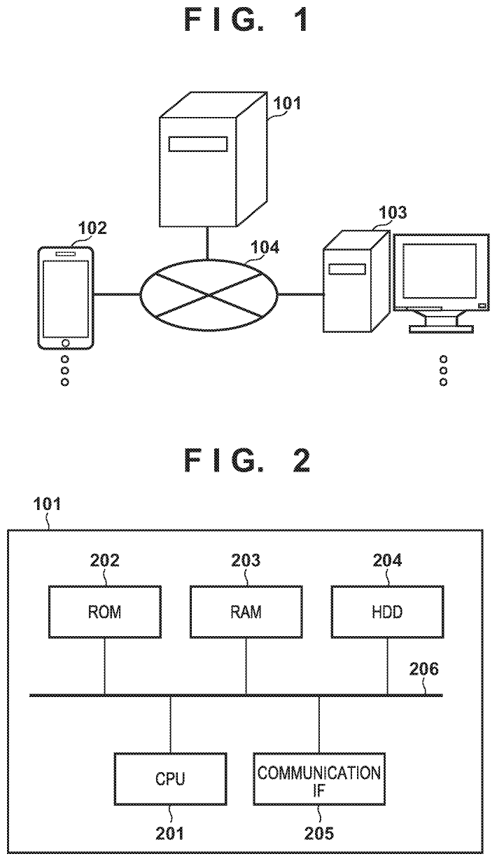

FIG. 1 is a configuration diagram of a field investigation system according to an embodiment.

An investigator inputs data acquired by observation in a farm field (hereinafter, investigation data) to a farm field investigation apparatus 102. The farm field investigation apparatus 102 uploads the input investigation data to an information processing apparatus 101 via a network 104. Here, the farm field investigation apparatus 102, which is an apparatus including a communication unit and a data input unit, may typically be a terminal such as a smart phone.

The information processing apparatus 101 receives investigation data via the network 104, performs an aggregation process on the received investigation data, and discloses the aggregation process result.

A person in charge of wine production or a farm field manager uses a growth management apparatus 103 to refer to the aggregation result provided by the information processing apparatus 101 via the network 104.

FIG. 2 is a diagram illustrating a hardware configuration of the information processing apparatus 101 in the system of FIG. 1. The information processing apparatus 101 includes a CPU 201, a Read-Only Memory (ROM) 202, a Random Access Memory (RAM) 203, an HDD 204, a communication interface 205, and a system bus 206.

The CPU 201, which stands for Central Processing Unit, performs arithmetic operation, logical decision or the like for various processes, and controls respective components connected to the system bus 206. The ROM 202, which is a program memory, stores programs for control by the CPU 201, including various processing procedures described below. The RAM 203 is used as the main memory of the CPU 201, and a temporary storage area such as a work area. The HDD 204 is a storage device configured to store electronic data and programs according to the present embodiment.

The CPU 201 reads and executes a program stored in ROM 202 to realize processes in accordance with respective flowcharts described below. Subsequently, the CPU 201 stores the result of each process in the RAM 202 or the HDD 204. Here, the program memory may be realized by loading a program stored in the ROM 202 to the RAM 202. The program memory may also be realized by loading a program stored in the HDD 204 to the RAM 202.

The communication interface 205 is an interface configured to perform, regardless of wired or wireless, bi-directional communication with other information processing apparatuses, communication apparatuses, external storage apparatuses or the like, using known communication techniques.

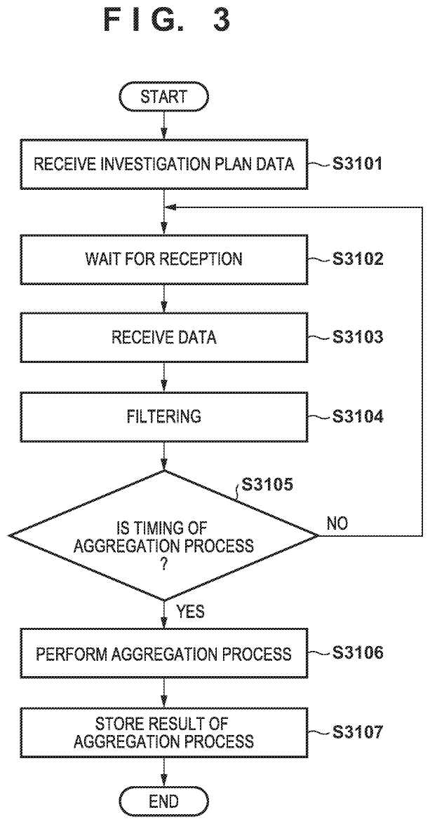

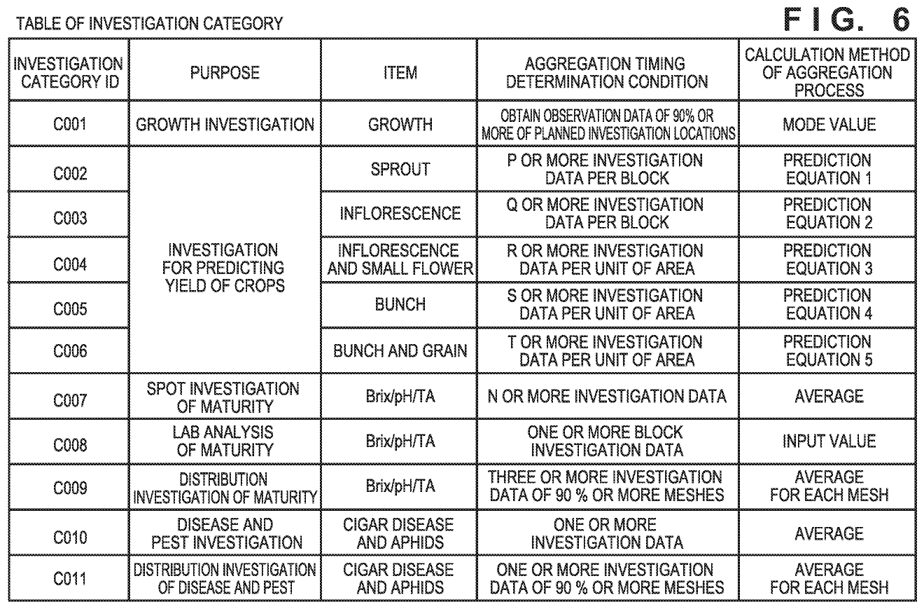

FIG. 3 is a flowchart illustrating a process procedure of an application that performs an aggregation process of investigation data, the application being performed by the CPU 201 of the information processing apparatus 101 in a certain investigation. While performing the process according to the flowchart, the CPU 201 treats data listed in the tables illustrated in FIGS. 6 to 8B.

FIG. 6 illustrates a table of investigation categories according to the embodiment. The table, which has been preliminarily registered and held in the HDD 204 or the ROM 202, is loaded to the RAM 203 and the CPU 201 as necessary. The investigation category table includes fields of investigation category ID, investigation purpose, investigation item, aggregation timing determination condition, and calculation method of aggregation process. The investigation category ID is a code for identifying the type of investigation, with other fields being defined in relation to this code. Here, the investigation purpose is information representing the purpose of investigation, such as degree of growth investigation, yield prediction investigation, degree of maturity investigation, disease and pest investigation or the like. In addition, the investigation item is information representing an item to be investigated, such as degree of growth investigation for determining the growth stage of a plant, sugar content or acidity in degree of maturity investigation, type of disease or type of insect in disease and pest investigation. Furthermore, the aggregation timing determination condition is a condition of a degree of area relative to the area of the farm field for determining whether or not to cause the information processing apparatus 101 to execute the aggregation process upon receiving investigation data corresponding to the degree of area. The calculation method of aggregation process is a calculation method of the aggregation process performed based on the investigation purpose or investigation item. In the case of degree of growth investigation, for example, the calculation method corresponds to an equation for calculating the mode of investigation data. In the case of yield prediction investigation, the calculation method corresponds to a yield prediction calculation equation based on respective investigation items. In the case of spot investigation of the degree of maturity, the calculation method corresponds to an equation for calculating the mean over respective investigation items. In the case of distribution investigation of disease and pest, the calculation method corresponds to an equation for segmenting an investigation block into meshes and quantifying the situation of disease and pest for each mesh. For example, the mode over respective meshes is calculated.

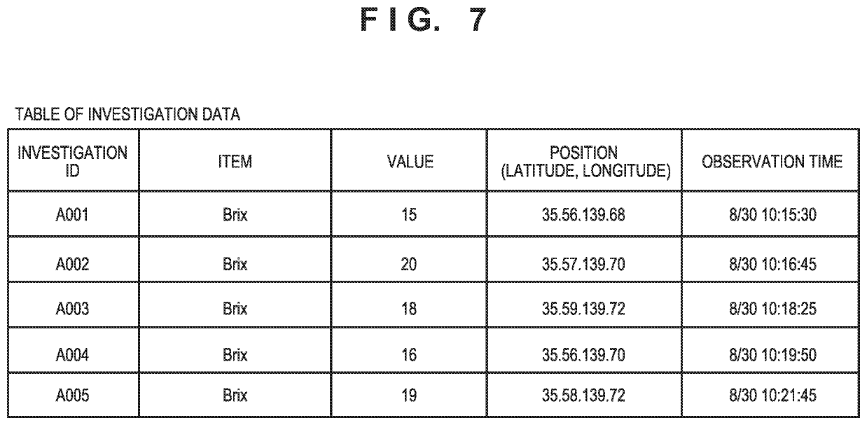

FIG. 7 illustrates a table of investigation data. The investigation data includes ID of investigation data, investigation item, value, observed position (latitude, longitude), and information of observation time point. Here, the investigation item is the investigation item of FIG. 6.

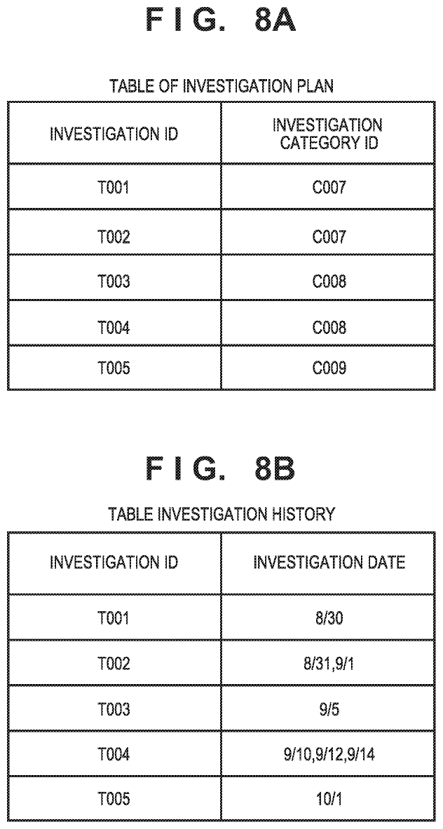

FIG. 8A illustrates a table of investigation plan. For each investigation, an investigation ID for identifying an investigation unit and an investigation category ID representing an investigation purpose and an investigation item are registered. Here, the investigation category ID is the investigation category ID of FIG. 6. Using fully ripe grapes allows for producing top-quality wine. Therefore, the degree of maturity investigation is repeated in wine grape cultivation to pin-point the harvest timing. The investigation ID is used when repeating investigation of a same investigation category for a plurality of times.

FIG. 8B illustrates a table of investigation history. For each investigation, the investigation ID and the investigation date on which investigation is conducted are managed. Here, the investigation ID is the investigation ID illustrated in FIG. 8A.

Next, an aggregation process of investigation data performed by the information processing apparatus 101 will be described, referring to the flowchart illustrated in FIG. 3. The flowchart is supposed to handle data of the tables of FIGS.6 to 8 described above.

At S3101, the CPU 201 receives the investigation plan data of FIG. 8A and stores the same in the HDD 204.

At S3102, the CPU 201 waits for reception of the investigation data of FIG. 7 or the investigation history data of FIG. 8B.

At S3103, the CPU 201 receives the investigation data of FIG. 7 or the investigation history data of FIG. 8B, and stores the same in the HDD 204.

The investigation data or the investigation history data can be uploaded from the farm field investigation apparatus 102 to the information processing apparatus 101 at an arbitrary timing. Accordingly, the information processing apparatus 101 may occasionally receive data related to a certain investigation for a plurality of times. The CPU 201 adds an investigation date other than an already recorded investigation date for a same investigation ID in the investigation history data of FIG. 8B. The investigation ID “T002” of FIG. 8B indicates that the investigation extends over two days: 8/31 (August 31) and 9/1 (September 1). The investigation history data may be received twice, i.e., one for each investigation date, or investigation history data extending over two days may be received in a single occasion, or the like. When investigation is performed on two farm field investigation apparatuses 102 on a same investigation day, although the result is that investigation history data of overlapping investigation dates is received from each of the farm field investigation apparatuses 102, the investigation date of the farm field investigation apparatus 102 is recorded with duplicate investigation dates being omitted.

Here, investigation data may be received in a manner such as bundling a plurality of cases into a single batch, or may be received as a set of investigation data and investigation history data of a plurality of cases. Receiving data as a batch or a set allows for reducing the number of execution times of a process performed by the CPU 201 as described below, thereby reducing the load of the CPU 201.

At S3104, the CPU 201 performs a filtering process. In the filtering process, a data set of investigation data to be used for the aggregation process is acquired using the aforementioned investigation category table, investigation plan table, and investigation history table.

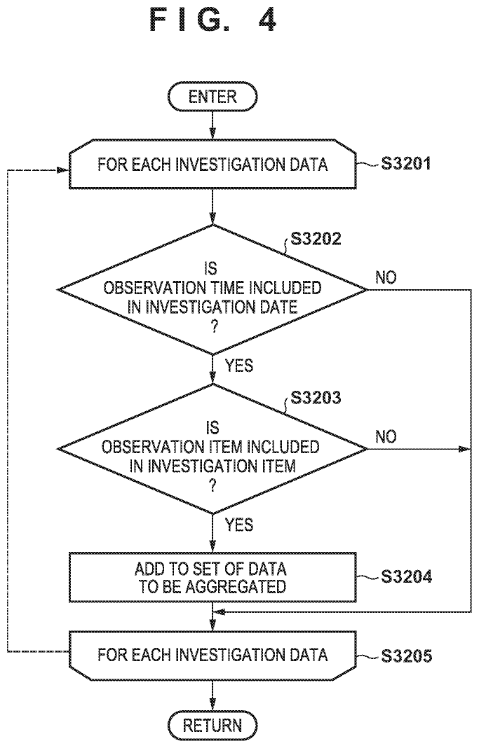

Here, details of the filtering processing at S3104 will be described, referring to the flowchart of FIG. 4. The loop of from S3201 to S3205 in FIG. 4 will be performed by the CPU 201 on the investigation data stored in the HDD 204.

Note that there are a large number of investigation data, and therefore filtering may be performed more efficiently by performing a process to limit the range of investigation data to be filtered prior to the processing in FIG. 4.

For example, a wine grape cultivation system divides the management region of investigation data for each vintage. In addition, the period of vintage is defined. Performing management using the aforementioned vintage information defines the management region of investigation data based on the investigation date recorded in the investigation history, and limits the range of investigation data to be processed in the flowchart of FIG. 4.

In addition, for example, the major classification of investigation (yield prediction investigation, disease and pest investigation, degree of maturity investigation, etc.) is defined so that investigation items are independent, and investigation categories are managed in association with the major classification of investigation. Management regions of investigation data are managed in a divided manner for each major classification of investigation. As a result, it becomes possible to limit the range of investigation data to be processed in the flowchart of FIG. 4.

Furthermore, the range of investigation data to be processed in the flowchart of FIG. 4 may be limited by managing, in a divided manner, the management region of the investigation data, using both the vintage and the major classification of investigation.

In addition, in order to reduce the loop for a large number of investigation data, the data set of investigation data of the result of filtering may remain an empty data set without performing the loop of the filtering process in the absence of investigation history.

At S3202, the CPU 201 determines whether or not an observation time point of the investigation data is included in the investigation date of the investigation history. When it is determined that the time point is included, the CPU 201 advances the process to S3203, otherwise advances the process to S3205 which is the end of the process.

At S3203, the CPU 201 determines whether or not an observation item of the investigation data is included in the investigation item in the investigation plan. When it is determined that the observation item is included, the CPU 201 advances the process to S3204, otherwise advances the process to S3205 which is the end of the loop.

At S3204, the CPU 201 adds the investigation data to the set of data to be aggregated.

At the end of loop, the CPU 201 determines whether or not the loop processing on the investigation data stored in the HDD 204 is completed. When there exists investigation data yet to be processed, the process returns to S3201, the start of loop, from which similar determination and processing are repeated. Upon completion of the loop processing on the investigation data, the process exits the sub-flow illustrated in FIG. 4. In a case where the investigation data is stored in a relational database, it is possible to acquire a data set to be used for aggregation process at one time by using SQL instead of the loop processing.

Let us return to the explanation of the flowchart of FIG. 3. At S3105, the CPU 201 determines whether or not to perform the aggregation process using the aggregation timing determination condition of FIG. 6 and the aggregation target data set subjected to the filtering process at S3104. The aggregation timing determination condition is provided for each investigation category ID, the investigation category ID being identified by the investigation category ID of the investigation plan data received at S3101. Upon determining that the timing for performing the aggregation process has arrived, the CPU 201 advances the process to S3106. Alternatively, upon determining that the timing for performing the aggregation process has not arrived, the CPU 201 returns the process to S3102 and waits for reception of investigation data or investigation history data.

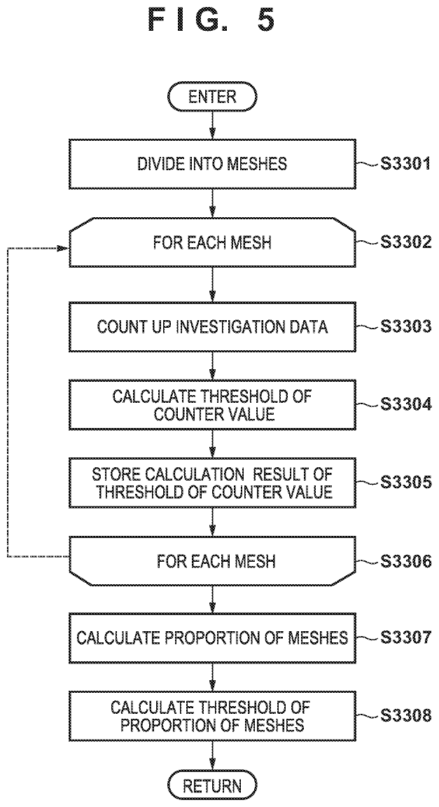

Here, the determination process at S3105 of FIG. 3 will be described referring to the flowchart of FIG. 5, taking as an example the investigation category ID: C009 of FIG. 6, i.e., distribution investigation of the degree of maturity.

At S3301, the CPU 201 divides the investigation block into meshes. The longitudinal length and the horizontal length of a mesh are parameters adjusted taking into account the spacing between ridges, pruning method of grape trees, and density required for performing investigation, which are preliminarily stored in the HDD 204. The contour of an investigation block is stored in the HDD 204 in a form of an array of latitudes and longitudes, such as the GeoJSON format (format for describing Geographic Information System (GIS) data based on the JavaScript Object Notation (JSON)). The investigation block is divided into mesh regions according to the longitudinal length and the horizontal length of a mesh, and the vertex information for each mesh is stored in the HDD 204 in a form of an array of latitudes and longitudes such as the GeoJSON format.

The loop from S3302 to S3306 is a process on each of the meshes divided at S3301. At S3303, the CPU 201 determines, for the investigation data filtered at S3104, whether or not the data is inside or outside a mesh and, when the data is inside the mesh, counts up a counter prepared for each mesh. The inside-or-outside determination uses the Crossing Number Algorithm, the Winding Number Algorithm, or the like.

$$[ Equation 1 ]$$

$${m}_{i} = \{ \begin{matrix}0 & c < {θ}_{c} \\ 1 & c \geq {θ}_{c}\end{matrix} \qquad ( 1 )$$

Here, mᵢ is a calculation result of counter value of i-th mesh and threshold, c is the counter value, and θc is the threshold for the counter value.

At S3304, the CPU 201 compares, in Equation (1), the counter value of the investigation data for each mesh with a threshold of investigation data required for each mesh, and calculates whether or not the number of investigation data is equal to or larger than the threshold. In the example of FIG. 6, the threshold of the investigation category ID is 3, according to the aggregation timing determination condition.

At S3305, the CPU 201 stores the determination result in the RAM 203. The CPU 201 is supposed to repeatedly perform the loop from S3302 to S3306 for all the meshes in the investigation block.

$$[ Equation 2 ]$$

$${R}_{d} = \frac{1}{n} {\sum }_{i = 1}^{n} {m}_{i} \qquad ( 2 )$$

Here, R_{d} is a proportion of meshes with count value equal to or larger than threshold, n is the number of meshes inside block, and mᵢ is a calculation result of the counter value of i-th mesh and threshold.

At step S3307, the CPU 201 calculates, according to equation (2), a proportion of meshes with a count value equal to or larger than the threshold of the count value of investigation data relative to the total number of meshes.

$$[ Equation 3 ]$$

$$result = \{ \begin{matrix}false & {R}_{d} < {θ}_{r} \\ true & {R}_{d} \geq {θ}_{r}\end{matrix} \qquad ( 3 )$$

Here, R_{d} is a proportion of meshes with count value equal to or larger than threshold, and θr is the threshold of the mesh proportion.

At S3308, the CPU 201 calculates, in equation (3), whether or not the proportion of the mesh with a count value equal to or larger than the threshold is equal to or larger than a threshold of the mesh proportion. The response is TRUE when the proportion is equal to or larger than the threshold, and the response is FALSE when the proportion falls below the threshold. In the example of the investigative category ID: C009 of FIG. 6, the threshold of mesh proportion is 0.9. When the response of the process of FIG. 5 is TRUE, determination at S3105 of FIG. 3 turns out to be YES and the CPU 201 advances the process to S3106. When, on the other hand, the response of the process of FIG. 5 is FALSE, determination at S3105 of FIG. 3 turns out to be NO, and the CPU 201 returns the process to S3102.

The aggregation process at S3106 performs processing of the set of investigation data filtered at S3104, according to the calculation method of the aggregation process corresponding to each of the investigation categories of FIG. 6. The calculation method of the aggregation process includes calculation of mode, mean, yield prediction equation, or the like.

At S3107, the CPU 201 stores the calculation results of the aggregation process in the HDD 204.

When there is a query from the growth management apparatus 103 via the network 104, the information processing apparatus 101 is supposed to respond with the latest aggregation result stored in the HDD 204. When the aggregating process is performed on a same investigation ID for a plurality of times, the information processing apparatus 101 responds with the last aggregation result. Additionally, in a case where the aggregation process has never been performed on a certain investigation ID, the information processing apparatus 101 responds, when there is a query, to notify an uncompleted aggregation.

Here, a method may be used that notifies the growth management apparatus 103 of the aggregation result from the information processing apparatus 101, in a case where the information processing apparatus 101 has performed and completed the aggregation process.

Investigation of wine grape cultivation is often manually performed. Effectively, investigation is performed by a plurality of persons in a shared manner when the farm field to be investigated is large. Each investigator, upon completion of each investigation, then uploads investigation data to the information processing apparatus. In such a situation, there may arise a state that, at a certain timing, the investigation data managed by the information processing apparatus is an insufficient data set. On the other hand, in the presence of bias in growth situation of grapes and damage caused by disease and pest, aggregation based on an insufficient data set may result in a gap between the aggregation result based on the investigation data and the actual situation of the farm field.

Using the method described in the first embodiment, aggregation is performed in a situation that the investigation data is sufficient as a data set corresponding to the investigation category in grape cultivation, and it becomes possible to prevent the aggregation result managed by the information processing apparatus from becoming erroneous information.

In addition, conventional techniques require a long aggregation interval in order to prevent introduction of erroneous information. In contrast, the first embodiment determines the aggregation timing at the timing of receiving data. Therefore, the time lag from receiving the data to disclosing the aggregation result by the information processing apparatus becomes shorter compared with conventional techniques.

In addition, the first embodiment presents means for converting position information of investigation data into time information, i.e., aggregation timing. With regard to wine grapes, there may arise positional bias in the growth situation or damage caused by disease and pest in the farm field. For investigation of crops with occurrence of positional bias as described above, the method of determining the aggregation timing taking into account position information is more effective in terms of determining whether or not the data set of investigation data is sufficient than the method of determining the aggregation timing based on only the time information according to conventional techniques.

Additionally, in wine grape cultivation, progress management of investigation in the farm field has been very troublesome due to concurrently planning and performing a plurality of investigations, or sharing one investigation by a plurality of investigators. In contrast, using the method described in the first embodiment allows the information processing apparatus to automatically determine the aggregation timing, and perform the aggregation process based on determination results, whereby progress management of investigation in the farm field becomes easier than conventional techniques.

### Second Embodiment

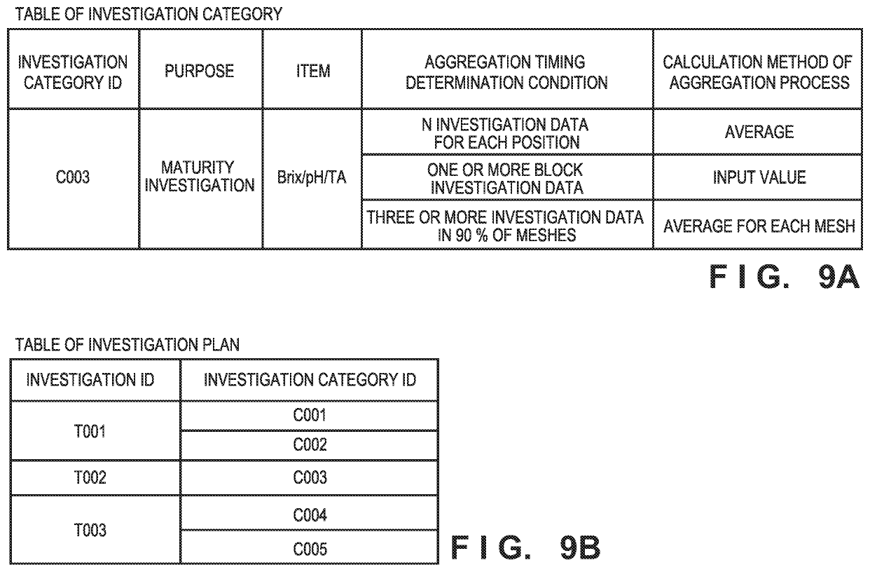

In the first embodiment, a case has been described where one aggregation timing determination condition is associated with each investigation category ID. However, there may be a plurality of aggregation timing determination conditions or calculation methods of the aggregation process for one investigation category ID, as illustrated in FIG. 9A. In this case, the determination process at S3105 and the processes at S3106 and S3107 of FIG. 3 are performed for each aggregation timing determination condition and corresponding aggregation process.

Accordingly, when performing a plurality of aggregation processes on one investigation, respectively at different aggregation timings, it becomes possible to perform each aggregation process at a suitable timing for the aggregation process, and refer to aggregation results in the order of completion of the aggregation processes.

### Third Embodiment

In the first embodiment described above, although a case has been described with one investigation category ID being associated with each investigation ID, a plurality of investigation category IDs are registered and managed for one investigation ID as illustrated in FIG. 9B when using investigation data acquired in a certain investigation for a plurality of investigation purposes. In a case where a certain investigation has been completed, the filtering process at S3104, the aggregation timing determination process at S3105, the aggregation process at S3106, and the aggregation result storing process at S3107 of FIG. 3 are performed for each of the investigation categories corresponding to the investigation of FIG. 9B. When there are a purpose of analyzing daily situation and a purpose of performing a large-scale investigation extending over a plurality of days, the present embodiment allows for referring to the daily situation within that day and, in the case of a large-scale investigation, allows for aggregation and reference upon completion of the investigation.

Of the two purposes, aggregation with a purpose to analyze the daily situation may be constantly operated without being explicitly registered in the various tables described above. In other words, the farm field investigation apparatus 102 may perform aggregation on a daily basis each time investigation data is received from the information processing apparatus 101, and disclose the aggregation result to the growth management apparatus 103, concurrently with aggregation performed at a timing corresponding to the investigation category illustrated in the first embodiment.

### Fourth Embodiment

Although there has been described in the first embodiment a method that uses the number of investigation data as the aggregation timing determination condition, there will be described a method in a fourth embodiment that uses, as the determination condition, a knowledge of whether or not investigation data have been received from the farm field investigation apparatus.

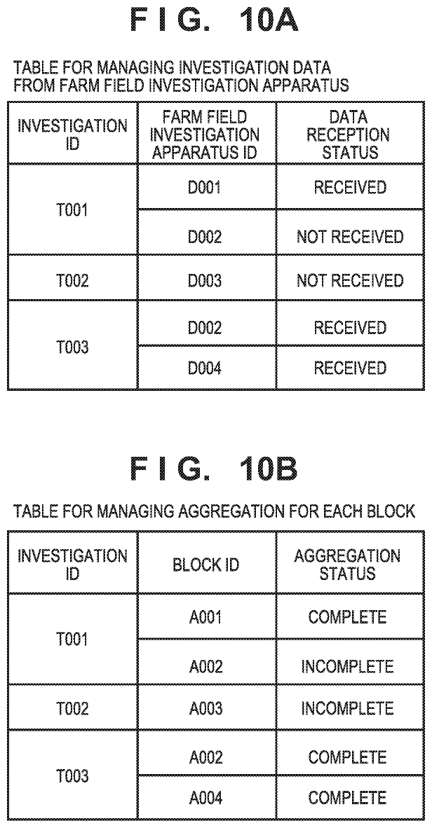

FIG. 10A is a table for managing the transmission status of investigation data from the farm field investigation apparatus 102 to the information processing apparatus 101. The management table includes fields of investigation ID, farm field investigation apparatus ID, and data reception status. The farm field investigation apparatus 102, having assigned thereto a farm field investigation apparatus ID as identification information, registers the investigation ID and the farm field investigation apparatus ID when planning an investigation. At this time point, investigation data have not been received and therefore “not received” is registered as the data reception status.

Upon receiving investigation data at S3103 of FIG. 3, the CPU 201 of the information processing apparatus 101 refers to the investigation ID and the farm field investigation apparatus ID of the received data, and updates the corresponding data reception status field to “received”. At S3105, the CPU 201 determines whether or not data reception status of all the farm field investigation apparatuses for a certain investigation have been “received”. When all the data reception status for a certain investigation are “received”, the determination turns out to be YES, and when there are one or more “not received” indications, the process proceeds to NO. Processing for the case of YES and the case of NO is similar to the method described in the first embodiment.

Note that the sequence of timings for the filtering at S3104 and the determination process at S3105 may be switched in the fourth embodiment, in order to efficiently perform the calculation process of the information processing apparatus 101. Since the fourth embodiment uses the table for managing the transmission status of the investigation data from the farm field investigation apparatus 102 to the information processing apparatus 101, the determination process at S3105 may be performed with a smaller amount of calculation than the first embodiment. Since the filtering process at S3104 is not performed when the result of determination at S3105 is NO in a case where the sequence has been switched, it is possible to reduce the calculation by a matching amount.

### Fifth Embodiment

In a fifth embodiment, there will be described an example of managing the farm field divided into a plurality of blocks, and determining the timing of aggregation process on each block.

FIG. 10B is a table for managing the aggregation status of the information processing apparatus 101 for each block in each investigation. The table includes fields of investigation ID, block ID, and aggregation status, and the investigation ID and the block ID of the block targeted by the investigation are registered in the table when planning an investigation. The aggregation status at the time point of planning is “uncompleted”.

Steps S3104, S3105, S3106 and S3107 of FIG. 3 are performed for each block. At S3103, the CPU 201, upon receiving the investigation data, updates the aggregation status of FIG. 10B to “completed” for the block to which the investigation data belongs. In the fifth embodiment, it is determined whether or not the aggregation status of all the block IDs belonging to the investigation ID targeted in FIG. 10B has become “completed’ after S3107. When the aggregation status of all the block IDs belonging to the target investigation ID is “completed”, the process proceeds to END, or the CPU 201 returns the process to S3102 when there exists an “uncompleted” block, and waits for reception of investigation data for the “uncompleted” block.

The method of performing aggregation concurrently for each block as in the fifth embodiment is effective in the degree of maturity investigation to determine the harvest date of each block. This is because the harvest date is determined by analyzing the temporal change of the degree of maturity for each block. Accordingly, performing aggregation for each block at a timing when sufficient investigation data for the block have been collected allows for referring to aggregation results in some of the blocks earlier than performing aggregation after investigation data for all the blocks have been collected.

Using the technique of the present embodiment as has been described above allows for automatically aggregating a more appropriate data set of investigation data at a more appropriate timing than conventional techniques, in a case where the information processing apparatus irregularly receives, for a plurality of times, investigation data for a certain investigation purpose.

In addition, determination of the aggregation timing by the information processing apparatus is automatically performed, and therefore progress management of investigation in the farm field and aggregation of investigation results becomes easier than the method that manually instructs the aggregation timing.

### Other Embodiments

Note that the aggregation timing determination condition of FIG. 6 may alternatively be determined using a learned model subjected to machine learning. In such a case, for example, preparing a plurality of combinations of input data to the determination unit and determination results as learning data, and acquiring the knowledge from the learning data by machine learning, and thus a learned model that outputs determination results for the input data based on the acquired knowledge is generated. The learned model may be configured by a neural network model, for example. Furthermore, the learned model, as a program for performing processes comparable to the aforementioned processing unit, operates in conjunction with a CPU, a GPU, or the like so as to perform processes intended to be performed by the processing unit. Here, the learned model may be updated after execution of a certain process as necessary.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2019-143920, filed Aug. 5, 2019, which is hereby incorporated by reference herein in its entirety.

What is claimed is:

1. An information processing apparatus configured to manage and aggregate information relating to crops in a farm field, comprising:
a management unit configured to receive and manage investigation data relating to crops in a farm field or to the farm field;
a determination unit configured to determine, upon reception of the investigation data by the management unit, whether or not an aggregation timing of the investigation data has arrived, based on whether or not number of investigation data managed by the management unit has exceeded a predetermined number determined in accordance with investigation; and
an aggregation unit configured to perform an aggregation process of the investigation data in response to a query of the investigation data, when the determination unit determines that the aggregation timing has arrived.

2. The information processing apparatus according to claim 1, further comprising
a filtering unit configured to perform filtering of investigation data to be aggregated from the investigation data managed by the management unit, wherein
the determination unit is configured to determine whether or not the aggregation timing of the investigation data has arrived, using the investigation data filtered by the filtering unit for aggregation.

3. The information processing apparatus according to claim 2, wherein the filtering unit is configured to perform filtering of the investigation data for aggregation, in a case where an observation time point of investigation data managed by the management unit is included in an investigation item in an investigation plan, and an observation item of the investigation data is included in an investigation item.

4. The information processing apparatus according to claim 1, wherein the determination unit is configured to determine an aggregation timing for investigating a plurality of investigation items, in accordance with an aggregation timing determination condition defined for each of the plurality of investigation items.

5. The information processing apparatus according to claim 1, wherein the determination unit is configured to determine that an aggregation timing for investigating a degree of growth of crops has arrived when there exist as many investigation data as a proportion equal to or larger than a predetermined proportion of planned investigation locations, and determine that an aggregation timing for predicting yield of crops has arrived when there are as many investigation data as a number equal to or larger than a predetermined number per block or unit area.

6. The information processing apparatus according to claim 1, wherein the aggregation unit is configured to perform an aggregation process for obtaining the mode in order to investigate a degree of growth of crops, an aggregation process for predicting yield of crops, an aggregation process for investigating degree of maturity of crops, or an aggregation process for investigating disease and pest.

7. The information processing apparatus according to claim 1, wherein the determination unit is configured to determine that an aggregation timing of the investigation data has arrived when proportion of meshes associated with number of investigation data corresponding to each mesh resulted from dividing an investigation block being equal to or larger than a threshold of investigation data required for each mesh is equal to or larger than a threshold.

8. The information processing apparatus according to claim 7, wherein the determination unit is configured to determine that an aggregation timing of investigation data has arrived when proportion of meshes associated with number of investigation data corresponding to each mesh being equal to or larger than a first threshold is equal to or larger than a second threshold, in a case of determining a timing of an aggregation process for investigating degree of maturity of crops, or in a case of investigating distribution of disease and pest.

9. The information processing apparatus according to claim 1, wherein the management unit is configured to receive investigation data from a farm field investigation apparatus that is different from the information processing apparatus.

10. The information processing apparatus according to claim 1, wherein the information processing apparatus is configured to respond with results of the aggregation process in response to query from outside.

11. The information processing apparatus according to claim 1, wherein the crops are wine grapes, and the information processing apparatus is configured to respond with results of the aggregation process in response to a query from a wine manufacturer.

12. The information processing apparatus according to claim 1, further comprising a second management unit configured to manage data reception status from a farm field investigation apparatus configured to transmit investigation data,
wherein the determination unit is configured to determine an aggregation timing based on data reception status from a farm field investigation apparatus to perform investigation.

13. The information processing apparatus according to claim 1, further comprising a holding unit configured to hold a table indicating relation between an item to be observed with regard to crops and a threshold of an area of a farm field indicated by investigation data of the item to be observed,
wherein the determination unit is configured to determine that an aggregation timing has arrived for an item to be observed whose area has become equal to or larger than the threshold, in a case where investigation data of an area of the farm field equal to or larger than the threshold is managed by the management unit.

14. The information processing apparatus according to claim 1, wherein the information processing apparatus is configured to perform a plurality of aggregation processes for one investigation, have an aggregation timing determination condition for each of the aggregation processes, and perform each of the aggregation processes in accordance with a determination result of each aggregation timing determination condition.

15. The information processing apparatus according to claim 1, further comprising a third management unit configured to manage a farm field in a manner divided into plurality of blocks,
wherein the determination unit is configured to determine an aggregation timing for each block, and
wherein the aggregation unit is configured to perform an aggregation process for each block.

16. The information processing apparatus according to claim 1,
wherein the investigation data includes position information, and
wherein the determination unit is configured to determine an aggregation timing in accordance with position information of investigation data.

17. A method of controlling an information processing apparatus configured to manage and aggregate information relating to crops in a farm field, the method comprising:
(a) receiving and managing investigation data relating to crops in a farm field or to the farm field;
(b) determining, upon reception of the investigation data in the receiving (a), whether or not an aggregation timing of the investigation data has arrived, based on whether or not number of investigation data managed in the managing has exceeded a predetermined number determined in accordance with investigation; and
(c) performing an aggregation process of the investigation data in response to a query of the investigation data, when the determining (b) determines that the aggregation timing has arrived.

18. A non-transitory computer-readable storage medium storing a program which, when read and executed by a computer, causes the computer to execute a method of controlling an information processing apparatus configured to manage and aggregate information relating to crops in a farm field, the method comprising:
(a) receiving and managing investigation data relating to crops in a farm field or to the farm field;
(b) determining, upon reception of the investigation data in the receiving (a), whether or not an aggregation timing of the investigation data has arrived, based on whether or not number of investigation data managed in the managing has exceeded a predetermined number determined in accordance with investigation; and
(c) performing an aggregation process of the investigation data in response to a query of the investigation data, when the determining (b) determines that the aggregation timing has arrived.
